(19) United States
(12) Patent Application Publication
(10) Pub. No.: US 2025/0055004 A1
(43) Pub. Date: Feb. 13, 2025

(54) INTEGRATED FUEL CELL COOLING SYSTEM AND METHODS THEREOF

(71) Applicant: Caterpillar Inc., Peoria, IL (US)

(72) Inventor: Umakanth SAKARAY, Dunlap, IL (US)

(73) Assignee: Caterpillar Inc., Peoria, IL (US)

(21) Appl. No.: 18/231,804

(22) Filed: Aug. 9, 2023

(51) Int. Cl. H01M 8/04029; H01M 8/0432; H01M 8/0438

(52) U.S. Cl. CPC H01M 8/04029; H01M 8/04358; H01M 8/04417; B60L 50/72; B60L 58/33; H01M 2008/1095; H01M 2250/20

(57) ABSTRACT

Integrated fuel cell cooling systems and methods can comprise or implement a first coolant circuit to process a first coolant; a second coolant circuit to process a second coolant, the second coolant being a dielectric fluid; a liquid-liquid heat exchanger operatively coupled to the first coolant circuit and the second coolant circuit; and a proton exchange membrane (PEM) fuel cell. The first coolant circuit and the second coolant circuit can be fluidly separated from each other.

### TECHNICAL FIELD

The present disclosure relates to an integrated fuel cell cooling system and methods and portions thereof.

### BACKGROUND

In a fuel-cell based power system, the heat released to the stack coolant can be in excess of 50% of the total chemical energy. For optimal performance of the fuel cell stack coolant can be required to be operating temperature in the range of 60-65° C. This can bring up a challenge to design machines and power systems which require them to operate at ambient temperatures as high as 50° Celsius. In addition, multiple power conversion electronics devices may also require cooling to maintain higher power density. Auxiliary devices like electric motors to drive fans and pumps required for each loop can make the system complex and/or inefficient.

In the context of proton exchange membrane (PEM) fuel cells, such PEM fuel cells can have stringent electrical conductivity requirements for the coolant that is used to cool the plates where the electro-chemical reactions take place. Unsuitably high conductivity in this dielectric coolant can cause short circuit events. Additionally, the PEM fuel cells may have stringent particulate size requirements, typically in the range of micrometers, to prevent clogging of narrow channels in bipolar plates. It is also noted that dielectric coolants may be relatively expensive, for instance, relative to so-called conventional coolant (e.g., 50-50 ethylene glycol mix), and furthermore may require stringent controls to maintain conductivity over time due to contact with cooling system portions.

U.S. Patent App. Pub. No. 2021/0188124 A9 (“the '124 patent publication”) describes a vehicle temperature management apparatus comprising a channel selection section that selects at least one of a chiller heat exchange channel, a radiator heat exchange channel, and a heater heat exchange channel as a channel of a refrigerant in a refrigerant circulation circuit; a switching control section that controls the channel switching section such that the channel switching section selects at least one of the chiller heat exchange channel, the radiator heat exchange channel, and the heater heat exchange channel; and an operation control section that controls an operation of a chiller. According to the '124 patent publication, when the radiator heat exchange channel or the heater heat exchange channel is selected as the channel of the refrigerant, the switching control section controls the channel selection section such that the channel selection section further selects the chiller heat exchange channel, and the operation control section does not operate the chiller. Notably, the '124 patent publication describes a refrigerant circulation circuit as a refrigerant channel for circulating a refrigerant that exchanges heat with a battery, a DC-DC converter, and an onboard charging apparatus, particularly where refrigerant circulation circuit includes a plurality of valves used to direct flow of the same coolant.

### SUMMARY

According to an aspect of the present disclosure, an integrated cooling system for a fuel cell-powered vehicle is disclosed or can be implemented or provided. The integrated cooling system can comprise: a first coolant circuit to process a first coolant, the first coolant being an ethylene glycol mixture; a second coolant circuit to process a second coolant, the second coolant being a dielectric fluid having a conductivity below a predetermined conductivity value; a liquid-liquid heat exchanger operatively coupled to the first coolant circuit and the second coolant circuit; electrical circuitry to provide electrical power for the fuel cell-powered vehicle; and a proton exchange membrane (PEM) fuel cell. The first coolant circuit and the second coolant circuit can be fluidly isolated from each other, the first coolant circuit can include a first fluid pump to circulate the first coolant through the first coolant circuit, the proton exchange membrane (PEM) fuel cell can include a second fluid pump to circulate the second coolant through the second coolant circuit, and/or the first coolant circuit can be without any three-way valves.

According to another aspect of the present disclosure, a method can be implemented. The method can include providing a first coolant circuit to process a first coolant; providing a second coolant circuit to process a second coolant, the second coolant being a dielectric fluid, the second coolant circuit including proton exchange membrane (PEM) fuel cell; and providing a liquid-liquid heat exchanger operatively coupled to the first coolant circuit and the second coolant circuit. The first coolant circuit and the second coolant circuit can be fluidly isolated from each other, and/or the first coolant circuit can be without any three-way valves.

According to yet another aspect of the present disclosure, an off-highway truck is disclosed or can be implemented or provided. The off-highway truck can comprise: a first coolant circuit to process a first coolant; a second coolant circuit to process a second coolant, the second coolant being a dielectric fluid; a liquid-liquid heat exchanger operatively coupled to the first coolant circuit and the second coolant circuit; and a proton exchange membrane (PEM) fuel cell. The first coolant circuit and the second coolant circuit can be fluidly separated from each other.

### BRIEF DESCRIPTION OF DRAWINGS

FIG. 1 is a schematic illustration of an example fuel cell machine, in accordance with examples of the disclosure.

FIG. 2 is a schematic illustration depicting an example control environment of the fuel cell machine of FIG. 1, according to examples of the disclosure.

FIG. 3 is a diagram of a fuel-cell-based electrical power supply system according to one or more embodiments of the present disclosure.

FIG. 4 is a block diagram of a cooling system for a fuel-cell-based power supply system according to one or more embodiments of the present disclosure.

FIG. 5 is a flow chart of a method or process according to one or more embodiments of the present disclosure.

### DETAILED DESCRIPTION

The present disclosure relates to an integrated fuel cell cooling system and methods and portions thereof. In particular, embodiments of the present disclosure pertain to an integrated fuel cell cooling system for proton exchange membrane (PEM) fuel cells and methods and portions thereof.

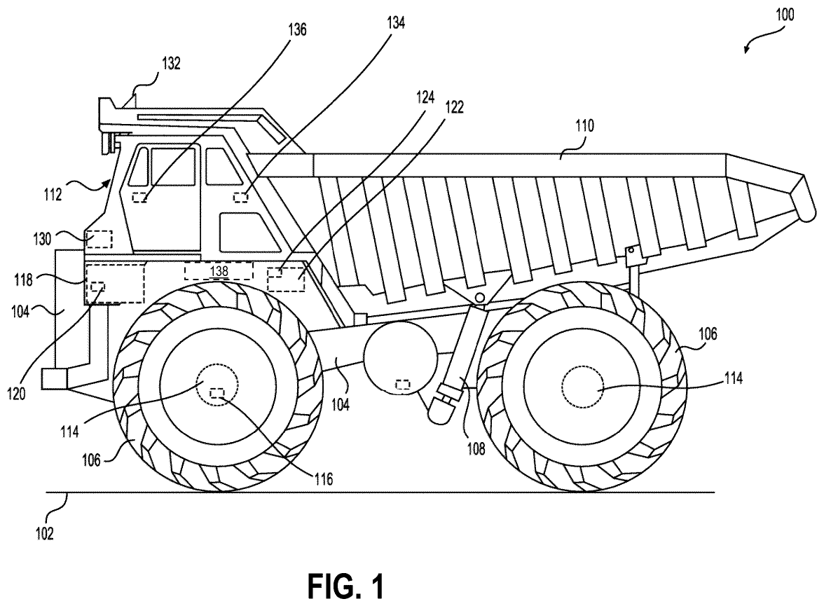

FIG. 1 is a schematic illustration of an example fuel cell machine 100, in accordance with one or more embodiments of the present disclosure. The fuel cell machine 100, although depicted as a mining truck type of machine, may be any suitable machine, such as any type of loader, dozer, dump truck, skid loader, excavator, compaction machine, backhoe, combine, crane, drilling equipment, tank, trencher, tractor, any suitable stationary machine, any variety of generator, locomotive, marine engines, combinations thereof, or the like. The fuel cell machine 100 can be configured for propulsion using one or more fuel cells, such as one or more polymer electrolyte membrane (PEM) fuel cells, also known as proton-exchange membrane fuel cells (MEMFCs).

The fuel cell machine 100 is illustrated as a mining truck, which can be used, for example, for moving mined materials, heavy construction materials, and/or equipment, and/or for road construction, building construction, other mining, paving and/or construction applications. For example, the fuel cell machine 100 can be used in situations where materials, such as mineral ores, loose stone, gravel, soil, sand, concrete, and/or other materials of a worksite need to be transported over a surface 102 at the worksite. As discussed herein, the fuel cell machine 100 may also be in the form of a dozer, where the fuel cell machine 100 can be used to redistribute and/or move material on the surface 102. It should be understood that the fuel cell machine 100 can be in the form of any other type of suitable construction, mining, farming, military, and/or transportation machine. In the interest of brevity, without individually discussing every type of construction and/or mining machine, it should be understood that the fuel cell drive mechanisms, as described herein, can be configured for use in a wide variety of fuel cell powered machines 100.

As shown in FIG. 1, the fuel cell machine 100 can include a frame 104 and wheels 106, though embodiments of the disclosed subject matter are not limited to wheels. The wheels 106 can be mechanically coupled to a drive train to propel the fuel cell machine 100. When the wheels 106 of the fuel cell machine 100 are caused to rotate, the fuel cell machine 100 traverses the surface 102. Although illustrated in FIG. 1 as having a hub with a rubber tire, in other examples, the wheels 106 may instead be in the form of drums, chain drives, combinations thereof, or the like.

The frame 104 of the fuel cell machine 100 can be constructed from any suitable materials, such as iron, steel, aluminum, other metals, ceramics, plastics, the combination thereof, or the like. The frame 104 can be of a unibody construction in some cases, and in other cases, can be constructed by joining two or more separate body pieces. Parts of the frame 104 can be joined by any suitable variety of mechanisms, including, for example, welding, bolts, screws, other fasteners, epoxy, combinations thereof, or the like.

The fuel cell machine 100 may include a hydraulic system 108 that can move a dump box 110 or other moveable elements configured to move, lift, carry, and/or dump materials. The dump box 110 can be used, for example, to pick up and carry dirt or mined ore from one location on the surface 102 to another location of the surface 102. The dump box 110 can be actuated by the hydraulic system 108, or any other suitable mechanical system. In some cases, the hydraulic system 108 can be powered by an electric motor, such as by powering hydraulic pump(s) of the hydraulic system 108. It should be noted that in other types of machines (e.g., machines other than a mining truck) the hydraulic system 108 may be in a different configuration than the one shown herein, may be used to operate elements other than a dump box 110, and/or may be omitted.

With continued reference to FIG. 1, the fuel cell machine 100 can also include an operator station 112. The operator station 112 can be configured to seat an operator therein. The operator seated in the operator station 112 can interact with various control interfaces and/or actuators within the operator station 112 to control movement of various components of the fuel cell machine 100 and/or the overall movement of the fuel cell machine 100 itself. According to one or more embodiments, the operator station 112 can be omitted or not used, in the case of remote or autonomous control of the fuel cell machine 100.

Thus, control interfaces and/or actuators within the operator station 112 can allow the control of the propulsion of the fuel cell machine 100 by controlling operation of one or more motors 114, each of which can be electric motors. A motor controller 116 may be controlled according to operator inputs received at the operator station 112. The motors 114 may be powered by a battery pack or battery 118, with a battery controller 120, and/or a fuel cell 122, with a fuel cell controller 124. According to one or more embodiments, only the fuel cell 122 and the fuel cell controller 124 can be implemented to power the motors 114 (and optionally other components of the fuel cell machine 100). Here, the fuel cell 122 can be comprised of one or more fuel cells. And, as noted above, each of the fuel cells can be a polymer electrolyte membrane (PEM) fuel cell, also known as proton-exchange membrane fuel cell (MEMFC).

The motors 114 may be of any suitable type, such as induction motors, permanent magnet motors, switched reluctance (SR) motors, combinations thereof, or the like. The motors 114 can be of any suitable voltage, current, and/or power rating. The motors 114 can control movement (including non-movement) of the fuel cell machine 100 as needed for tasks that are to be performed by the fuel cell machine 100. For example, the motors 114 may be rated for a range of about 500 volts to about 3000 volts. The motor controller 116 can include one or more control electronics to control the operation of the motors 114. In some cases, each motor 114 may be controlled by its own motor controller 116. In other cases, all the motors of the fuel cell machine 100 may be controlled by a single motor controller 116. The motor controller 116 may further include one or more inverters or other circuitry to control the energizing of magnetic flux generating elements (e.g., coils) of the motors 114. The motors 114 can be mechanically coupled to a variety of drive train components, such as a drive shaft and/or axles or directly to the wheels 106 to rotate the wheels 106 and propel the fuel cell machine 100. The drivetrain includes any variety of other components including, but not limited to a differential, connector(s), constant velocity (CV) joints, etc. It is also noted there may be one or more motors 114 that are not used for propulsion of the fuel cell machine 100, but rather to operate pumps and/or other auxiliary components, such as to operate the hydraulic systems 108.

According to examples of the present disclosure, the power to energize the motors 114 can be received from the battery 118, the fuel cell 122, or both the battery 118 and the fuel cell 122. In some cases, the motors 114 may operate solely from the power produced by the fuel cell 122. In other cases, the power received from the fuel cell 122 to operate the motors 114 may be supplemented by power from the battery 118. Fuel cells generally may provide a relatively steady level of power and generally do not ramp up or ramp down significantly or quickly from a baseline level of power. As a result, when a high level of power is needed to power the motors 114, power may be drawn from the fuel cell 122 and the battery 118 contemporaneously. According to examples of the disclosure, in some cases, the battery 118 may provide power for operating the motors 114 and/or other power consuming components (e.g., controllers, cooling systems, displays, actuators, sensors, etc.) of the fuel cell machine 100 while the fuel cell 122 is not providing power for operating the motors 114 and/or other power consuming components. In some cases, the motors 114 may be run using power from the fuel cell 122 or from a combination of the fuel cell 122 and the battery 118 until fuel for the fuel cell 122 is fully consumed. When the fuel is consumed, the fuel cell machine 100 may still be operated using power from the battery 118 until the battery 118 no longer has sufficient power to operate the fuel cell machine 100. In this way, the range and/or the time of operation of the fuel cell machine 100 can be extended beyond the range and/or time of operation of the fuel cell machine 100 according to the available fuel cell fuel available to the fuel cell machine 100.

In some cases, when the fuel cell machine 100 can be operated with energy from the battery 118 only, the fuel cell machine 100 may be operated in a derated mode. This derated mode may reduce the peak power consumed by the fuel cell machine 100, such that the peak power draw by the subcomponents (e.g., motors 114, controller, etc.) do not exceed the power rating of the battery 118. In this way, the fuel cell machine 100 may prevent damaging and/or excessively depleting the battery 118 during its operation using energy only from the battery 118. This derated mode may manifest in a reduced/limited speed, a reduced/limited force, or the like of actions performed by the fuel cell machine 100.

The battery 118 may be of any suitable type and capacity. For example, the battery may be a lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. The battery 118 may be organized as a collection of electrochemical cells arranged to provide the voltage, current, and/or power requirements of the motors 114.

The fuel cell 122 may be of any suitable type, such as a proton exchange membrane (PEM) fuel cell, a solid oxide fuel cell, an alkaline fuel cell, a solid-acid fuel cell, combinations thereof, or the like. As discussed herein, the energy output of the fuel cell 122 may be approximately similar to the energy output of the battery 118. In this type of energy ratio of the battery 118 and the fuel cell 122, the battery 118 may not only provide fast supplemental power to the motors 114 while the fuel cell 122 is also providing power to the motors 114, but the battery 118 can also be able to operate the fuel cell machine 100 after the fuel cell fuel is fully depleted. In this way, according to examples of the disclosure, the range and/or the time of operation of the fuel cell machine 100 can be extended beyond that of the fuel cell operation alone or fuel cell operation supplemented with battery power at the same time.

The fuel cell machine 100 can include an electronic control module (ECM) 130 that controls various aspects of the fuel cell machine 100. The ECM 130 can be configured to receive, as examples, battery status (e.g., state-of-charge (SOC) or other charge related metrics) from the battery controller 120; fuel cell status (e.g., state-of-charge (SOC) or other charge related metrics) from the fuel cell controller 124; status of a coolant or cooling system 200; and/or operator signal(s), such as an accelerator signal, based at least in part on the operator's interactions with one or more control interfaces and/or actuators of the fuel cell machine 100. In other cases, the ECM 130 may receive control signals from a remote control system by wireless signals, received via an antenna 132. The ECM 130 can use the operator signal(s), regardless of whether they are received from an operator in the operator station 112 or from a remote controller, to generate command signals to control various components of the fuel cell machine 100. For example, the ECM 130 may control the motors 114 via the motor controller 116, the fuel cell 122 via the fuel cell controller 124, the cooling system 200, the hydraulic system 108, and/or steering of the fuel cell machine 100 via a steering controller 134. It should be understood that the ECM 130 may control any variety of other subsystems of the fuel cell machine 100 that are not explicitly discussed here to provide the fuel cell machine 100 with the operational capability discussed herein.

The ECM 130, according to example of this disclosure, may be configured to provide an indication of remaining energy to operate the fuel cell machine 100 on an energy gauge 136. The energy gauge 136, according to examples of the disclosure, may be configured to display the amount of energy available to operate the fuel cell machine 100 based at least in part on the fuel remaining in the fuel cell and/or the amount of charge remaining in the battery 118, depending upon whether the fuel cell machine 100 has the fuel cell 122 or the fuel cell 122 and the battery 118. In some cases, the energy gauge 136 may provide an indication of an estimated amount of time the fuel cell machine 100 can be operated and/or an estimated amount of range the fuel cell machine 100 has remaining. These estimates may be generated based on the amount of fuel remaining in the fuel cell 122, charge remaining in the battery 118, recent usage of energy by the fuel cell machine 100, and/or an estimate of the energy expended per unit time (e.g., power requirement) of a task in which the fuel cell machine 100 is engaged. The energy gauge 136 may be configured to display, to an operator in the operator station 112, for instance, the amount of energy, time, and/or range remaining for operating the fuel cell machine 100. Additionally or alternatively, the energy gauge 136 and/or the ECM 130 may be configured to indicate, such as wirelessly via the antenna 132, the amount of energy, time, and/or range remaining for operating the fuel cell machine 100 to a remote operating system.

The ECM 130 can include single or multiple microprocessors, field programmable gate arrays (FPGAs), digital signal processors (DSPs), and/or other components configured to control the fuel cell machine 100. The microprocessor(s) can be configured to perform the functions of the ECM 130. Various circuits can be operably connected to and/or otherwise associated with the ECM 130 and/or the other circuitry of the fuel cell machine 100. Such circuits and/or circuit components can include power supply circuitry, inverter circuitry, signal-conditioning circuitry, actuator driver circuitry, etc. Embodiments of the present disclosure, in any manner, are not restricted to the type of ECM 130 or the positioning depicted of the ECM 130 and/or the other components relative to the fuel cell machine 100. The ECM 130 can be configured to control the use of energy from the battery 118 and the fuel cell 122 in a manner that enhances the range of the fuel cell machine 100.

The fuel cell machine 100 can further includes any number of other components within the operator station 112 and/or at one or more other locations on the frame 104. These components include, for example, one or more of a location sensor (e.g., global positioning system (GPS)), an air conditioning system, a heating system, communications systems (e.g., radio, Wi-Fi connections), collision avoidance systems, sensors, cameras, etc. These systems can be powered by any suitable mechanism, such as by using a direct current (DC) power supply powered by the fuel cell 122 and/or the battery 118.

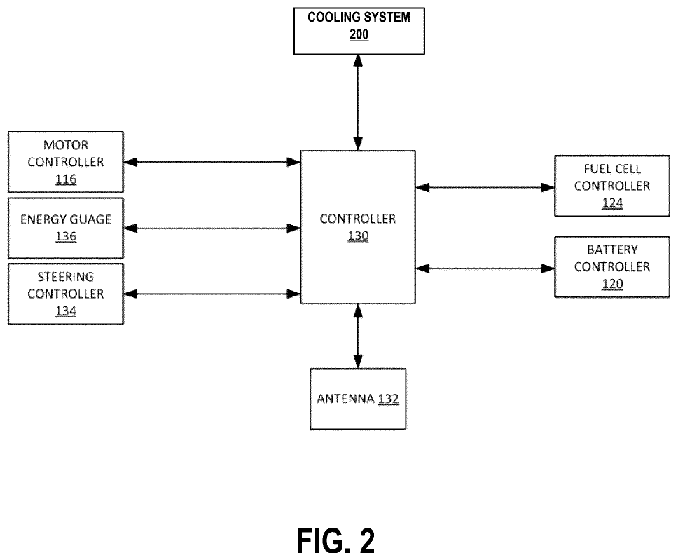

FIG. 2 is a schematic illustration depicting an example control environment of the fuel cell machine 100 of FIG. 1, according to examples of the present disclosure. As discussed herein, the ECM 130 may receive a variety of signals to process to enable that the fuel cell machine 100 operates to its energy capacity. Also as discussed herein, the ECM 130 may receive signals from the cooling system 200, for instance, one or more cooling system controllers and/or one or more sensors, such as one or more temperature sensors to sense temperature of various portions of the cooling system 200.

According to one or more embodiments, the ECM 130 may further receive an indication of an attribute of the battery 118 from the battery controller 120, such as a state-of-charge (SOC) or any other suitable metric. The ECM 130 may determine, based at least in part on the communication from the battery controller 120, an amount of energy available from the battery 118 to operate the fuel cell machine 100. The ECM 130 may be able to determine the total level of energy available to operate the fuel cell machine 100 based at least in part on the energy remaining in the battery 118.

The ECM 130 may command the fuel cell controller 124 to operate the fuel cell 122. In some cases, the ECM 130 may command the fuel cell controller 124 to operate the fuel cell 122 at constant and relatively efficient manner. If the level of current generated by the fuel cell 122 exceeds that needed for operating the fuel cell machine 100, the additional current may be used to charge the battery 118. The ECM 130 may also command the battery controller 120 to provide current to operate the fuel cell machine 100. In some cases, the battery 118 and the fuel cell 122 may provide electrical current contemporaneously to operate the fuel cell machine 100, such as to operate the motors 114.

In some cases, the ECM 130 may be configured to receive remote command(s) via the antenna 132. The ECM 130 may control the fuel cell machine 100 to perform a task based at least in part on the received remote command(s). In some cases, the task may be performed autonomously by the fuel cell machine 100, controlled by the ECM 130. The ECM 130 may control a variety of subsystems of the fuel cell machine 100, such as by controlling the motor controller 116 and/or the steering controller 134. According to examples of the disclosure, the ECM 130 may control the fuel cell machine 100 to perform the task even after all of the fuel cell fuel is depleted and until all of (or most) of the battery 118 is depleted. In additional examples of the disclosure, the ECM 130 may provide an indication of remaining energy, remaining estimated operation time, or the like, of the fuel cell machine 100, such as via the energy gauge 136.

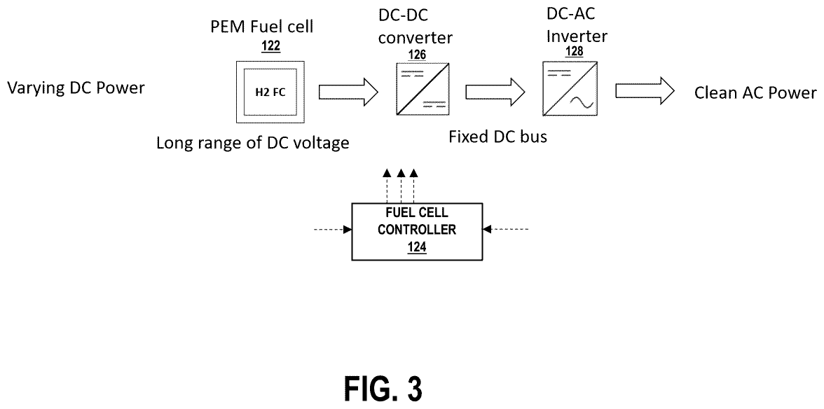

FIG. 3 is a diagram of a fuel-cell-based electrical power supply system 150 according to one or more embodiments of the present disclosure. The electrical power supply system 150 can include the fuel cell 122, the fuel cell controller 124, a converter 126, and an inverter 128. Generally, the electrical power supply system 150 can transform or convert, under control by the fuel cell controller 124, direct current (DC) voltage output from the fuel cell 122, which may vary, to alternating current (AC) voltage, via a DC-DC conversion by way of the converter 126. In this regard, the fuel cell controller 124 can receive feedback from the electrical power supply system 150, such as from voltage and/or current sensors, and output controlling signaling to the converter 126 and/or the inverter 128 to control power output from the inverter 128. The electrical power supply system 150 may be regarded as electrical circuitry to provide electrical power for the fuel cell machine 100, such as described above. The converter 126 and/or the inverter 128 can have IGBTs which switch at high frequency. Here, such IGBTs can be actively cool, in this case, by the liquid coolant. The temperature measured is at the junction commonly referred to as junction temperature. It may be desirable to maintain such temperature within a range of 125-150 degrees C., for instance. These IGBTs can be installed on a heat sink where the coolant circulates. Here, as an example, it may be desirable to have an inlet condition of 50-80 degrees C. to maintain junction temperatures (exact temperature depends on the flow rates achieved using a pumping system).

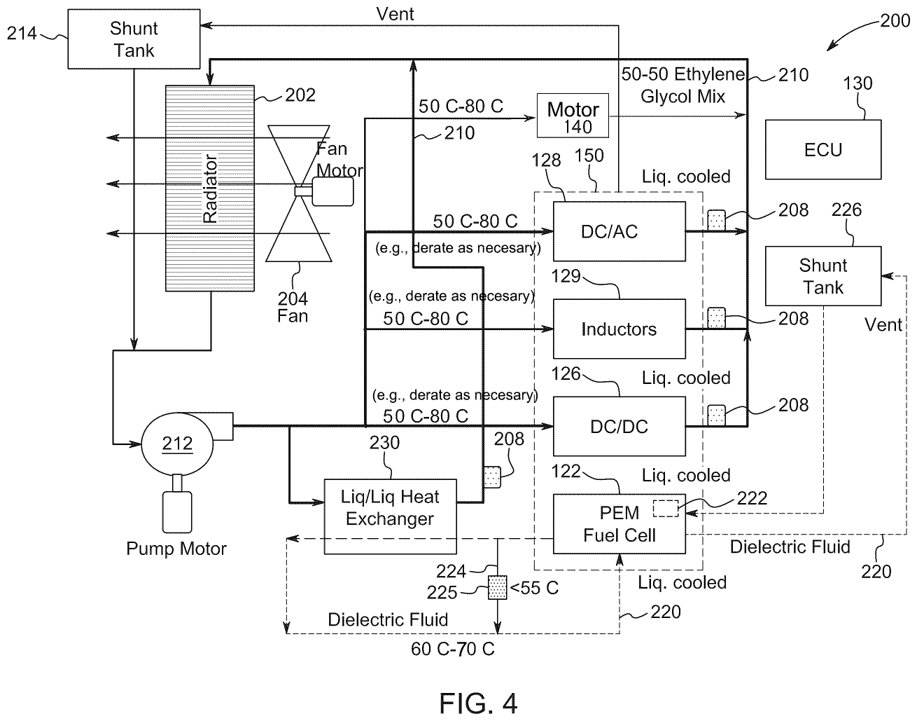

FIG. 4 is a block diagram of the coolant or cooling system 200 according to one or more embodiments of the present disclosure. Generally, the cooling system 200 can cool various portions of the fuel cell machine 100, including portions of the electrical power supply system 150. In an optional case where the fuel cell machine 100 also includes an internal combustion engine, the cooling system 200 can also cool the engine. The cooling system 200 can include or otherwise be operative relative to the fuel cell 122, which, as noted above, can also be part of the electrical power supply system 150, along with one or more inductors 129. Generally, the one or more inductors 129 can operate as filters for the converter 126 and/or the inverter 128.

The cooling system 200 can include a first coolant circuit 210 and a second coolant circuit 220. Generally, the first coolant circuit 210 can process a first coolant and the second coolant circuit 220 can process a second coolant different from the first coolant. Here, process can mean pass therethrough or circulate coolant. According to one or more embodiments, the first coolant circuit 210 may be without any valves (e.g., three-way valves) and/or the second coolant circuit 220 may be without any valves (e.g., three-way valves). That is, the first coolant circuit 210 and/or the second coolant circuit 220 may not have any valves.

According to one or more embodiments, the first coolant can be an ethylene glycol mixture, though embodiments of the present disclosure are not so limited. Also, according to one or more embodiments of the present disclosure, the second coolant can be a dielectric fluid having a conductivity below a predetermined conductivity value. The predetermined conductivity value may be 5 μS/cm or lower, according to one or more embodiments. In this regard, the second coolant may be regarded or characterized as a non-conductive liquid, for instance, that does not conduct any current.

The first coolant circuit 210 can include a fluid pump 212 to circulate the first coolant through the first coolant circuit 210. The second coolant circuit 220 can include a fluid pump 222 to circulate the second coolant through the second coolant circuit 220. The fluid pump 212 and the fluid pump 222 may be regarded as a first fluid pump and a second fluid pump, respectively. Control of the fluid pump 212 and/or the fluid pump 222 may be provided by the ECU 130, as an example. Discussed in more detail below, such control may be based on feedback, for instance, from one or more temperature sensors of or associated with the cooling system 200.

The cooling system 200 can also include a heat exchanger 230. According to one or more embodiments, the heat exchanger 230 can be shared by the first coolant circuit 210 and the second coolant circuit 220. That is, according to one or more embodiments of the present disclosure, the heat exchanger 230 can be regarded as part of the first coolant circuit 210 and part of the second coolant circuit 220. In that the heat exchanger 230 can be part of the first coolant circuit 210 and part of the second coolant circuit 220 to process the first coolant and the second coolant respectively, the heat exchanger 230 may be regarded as a liquid-liquid heat exchanger. Alternatively, the heat exchanger 230 may be considered separate from the first coolant circuit 210 and/or the second coolant circuit 220. The first coolant circuit 210 and the second coolant circuit 220 can be fluidly isolated or separated from each other. Thus, the first coolant and the second coolant may not intermix, even in a case where both coolants are processed, i.e., passed through, the heat exchanger 230.

An output of the fluid pump 212 can be provided to an input of the heat exchanger 230 and the electrical power supply system 150, such as shown in FIG. 4. An output of the fluid pump 222 can be provided to an input of the heat exchanger 230 different from the input associated with the output of the fluid pump 212, such as shown in FIG. 4. An output of the heat exchanger 230 can be provided to an input of the radiator 202, and another output of the heat exchanger 230 associated with the second coolant circuit 220 can be provided to an input of the fuel cell 122, for instance, to an input of the fluid pump 222 thereof.

The heat exchanger 230 can have different, separate or isolated zones or regions for the first and second coolants, one zone or region processing the first coolant and the other zone or region processing the second coolant. Thus, the heat exchanger 230 can exchange heat indirectly with respect to the first coolant and the second coolant. According to one or more embodiments, the heat exchanger 230 can be a plate-type heat exchanger with the separate/isolated zones or regions. Optionally, the inside of the heat exchanger 230, for instance, the plates and walls thereof in the case of the plate-type heat exchanger, can be made of stainless steel, as an example.

Optionally, the second coolant circuit 220 can include a bypass route or path 224 at an output of the fuel cell 122 and an input to the heat exchanger 230. The bypass 224 can be fed back to the input of the fuel cell 122, such as shown in FIG. 4. The bypass 224 can selectively bypass the second coolant from flowing through the heat exchanger 230. The bypass 224 can be operative to prevent or stop the second coolant from flowing through the heat exchanger 230 under a condition where a temperature of the second coolant is determined to be below a predetermined temperature value. As an example, the bypass 224 can include a valve 225 (mechanical or electronically controller) operative to selectively pass the second coolant based on the temperature of the second coolant relative to the predetermined temperature value.

The cooling system 200 can also include a shunt tank 214, a shunt tank 226, a radiator 202 and a fan 204 (which may be driven by an electric motor). An output line from the first coolant circuit 210 to the shunt tank 214 may be regarded as a vent. An output of the shunt tank 214 may be fed back to an input of the fluid pump 212, such as shown in FIG. 4. Likewise, an output line from the second coolant circuit 220, for instance, output from the fuel cell 122, to the shunt tank 226, may be regarded as a vent. An output of the shunt tank 226 may be fed back to an input of the fuel cell 122, such as shown in FIG. 4.

According to one or more embodiments, the cooling system 200 can include a plurality of sensors 208. The sensors 208 may be regarded as temperatures sensors and provided at various portions of the cooling system 200, such as shown in FIG. 4, to sense temperature as such positions. Outputs of the sensors 208 may be provided as respective inputs to a controller or control circuitry, such as to the ECU 130.

According to one or more embodiments of the present disclosure, the temperature feedback signals from one or more of the sensors 208 may be sent to the ECU 130 to control speed of the fan 204 for the radiator 202 and/or the speed of the fluid pump 212. Optionally, the ECU 130 may increase the speed of the fan 204 to a maximum value responsive to any of the temperature feedback signals from the sensors 208 exceeding a predetermined temperature threshold and/or may increase the speed of the fluid pump 212 to a maximum value responsive to any of the temperature feedback signals from the sensors 208 exceeding the predetermined temperature threshold. As shown in FIG. 4, the temperature sensors 208 can be provided at outputs of the electrical power supply system 150 and/or the heat exchanger 230, as the temperature of the first coolant as such outputs may be relatively higher than at the inputs to such components.

As examples, a temperature of the second coolant downstream of an output of the heat exchanger 230 can be from 60° Celsius to 70° Celsius, inclusive, and/or a second temperature of the first coolant at input to electrical power supply system 150 can be from 50° Celsius to 80° Celsius, inclusive. In the case of the cooling system 200 having the bypass 224, the bypass 224 may be operative to bypass the heat exchanger 230 when the temperature of the second coolant exiting the fuel cell 122 is fifty-five degrees Celsius or less. Thus, the predetermined temperature value for the bypass 224 can be, as an example, fifty-five degrees Celsius or less. Incidentally, the dashed lines can be regarded as corresponding to the second coolant circuit 220, for the dielectric/low conductivity coolant, whereas the solid lines can be regarded as corresponding to the first coolant circuit 210, for the first coolant (e.g., standard diesel engine low-cost coolant). Also, the thicker lines associated with the first coolant circuit 210 and the second coolant circuit 220 can indicate a relatively higher temperature for the first or second coolant, respectively, relative to the thinner lines associated with the first coolant circuit 210 and the second coolant circuit 220.

### INDUSTRIAL APPLICABILITY

The present disclosure relates to an integrated fuel cell cooling system and methods and portions thereof. In particular, as noted above, embodiments of the present disclosure pertain to an integrated fuel cell cooling system for proton exchange membrane (PEM) fuel cells and methods and portions thereof.

In a fuel-cell-based power system, the heat released to the stack coolant can be in excess of 50% of the total chemical energy. For suitable (e.g., optimal) performance of the fuel cell stack, coolant can be required to be operating temperature in the range of 60-65° C. This can bring up a challenge to design machines and power systems which require them to operate at ambient temperatures as high as 50° Celsius. In addition, multiple power conversion electronics devices may also require cooling to maintain higher power density. Auxiliary devices like electric motors to drive fans and pumps for each loop can make the system complex and/or inefficient.

In the context of Proton Exchange Membrane (PEM) fuel cells, such PEM fuel cells can have stringent electrical conductivity requirements for the coolant that is used to cool the plates where the electro-chemical reactions take place. Unsuitably high conductivity in this coolant can cause short circuit events. Additionally, the PEM fuel cells may have stringent particulate size requirements, typically in the range of micrometers, to prevent clogging of narrow channels in bipolar plates. It is also noted that dielectric coolants may be relatively expensive, for instance, relative to so-called conventional coolant (e.g., 50-50 ethylene glycol mix), and may require stringent controls to maintain conductivity over time due to contact with cooling system portions. Thus, using less dielectric coolant may be advantageous, at least in terms of expense.

At least in view of the foregoing, one or more embodiments of the present disclosure can involve or implement an integrated cooling system for cooling a fuel stack module such as PEM fuel cell module and one or more components such as DC/DC converters, inductors, etc.

As an example, the cooling system, according to one or more embodiments, can include a radiator, a liquid/liquid heat exchanger associated with the fuel cell module, and a coolant circulating within a cooling loop. In operation, the cooling system can cool the fuel cell module by utilizing the liquid/liquid heat exchanger and the coolant. Further, one or more components such as DC/DC converters and inductors can be cooled by utilizing the coolant. Further, the cooling system can direct the coolant to the radiator, thereby ensuring circulation of the coolant. The integrated cooling system, according to one or more embodiments of the present disclosure, can thereby facilitate cooling of the fuel stack and the one or more components by utilizing a single radiator and hence integrating one or more cooling loops.

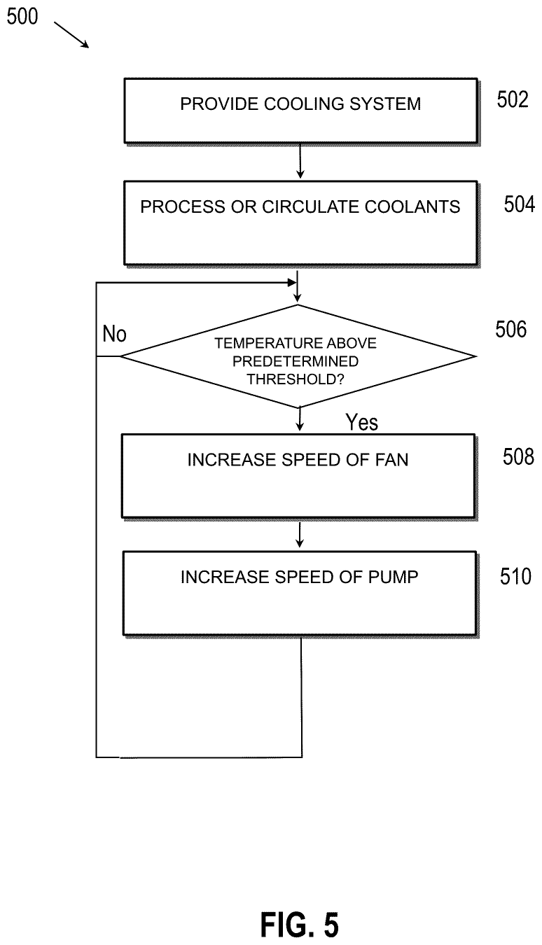

Also according to one or more embodiments of the present disclosure, a cooling system architecture can use a dielectric fluid to meet the stringent requirements and a standard radiator using ethylene glycol to cool the power electronics. A liquid-to-liquid heat exchanger can be used to circulate the dielectric fluid from the fuel cell and the ethylene glycol to dissipate the heat generated by the fuel cell to the ethylene glycol and then to be dissipated by the radiator using a cooling fan. The circulation pump of the fuel cell, which may be built into or included in the fuel cell, can circulate the dielectric fluid, and a stand-alone pump (e.g., electric) can circulate the ethylene glycol. Here, the electronic components, such as DC/DC converter, inverter, and/or inductors, may have around the same temperature requirements of the coolant if they are all liquid cooled systems. Hence, such the electronic components, according to embodiments of the present disclosure, can be cooled by the same radiator system. For example, as mentioned earlier, high switching devices like IGBTs can be cooled through a cold plate arrangement, while inductor elements used in filter and transformers typically require cooling to maintain insulation rating class so as to not exceed temperature limits of underlying windings and to improve their power density. For instance, a class 180 F class rated insulation material may require a maximum winding hot spot temperature to not exceed 180 degrees C. and an average winding temperature rise of 115 degrees C. This temperature may be maintained by using a liquid cooled inductor with an active coolant circulating around the inductor element. Also, one or more liquid cooled motors 140 may be used to cool motor and stator laminates; coolant channels around the motor housing can thus be used to circulate coolant. According to one or more embodiments, if one or more subsystems observe temperature exceeding their respective limits, a control system can take action to derate the system as necessary. For example on an occasional hot day at 50 degrees C. (e.g., desert in summer), the coolant might be get as hot as 80 degrees C. and some of the sub-systems could see higher insulation/junction temperatures, but they can self-protect themselves through control system action and reducing the power delivered. FIG. 5 is a flow chart of a method or process 500 according to one or more embodiments of the present disclosure. Portions of the method 500 can be controlled via a non-transitory computer-readable storage medium (or media) having stored thereon instructions that, when executed by one or more processors, such as one or more processors of the ECU 130, causes the one or more processors to perform the portions of the method 500. According to one or more embodiments, the method 500 may be referred to or characterized as a method for cooling.

The method 500, at 502, can comprise providing a coolant or cooling system, such as cooling system 200. This may include providing a coolant circuit, such as the first coolant circuit 210, to process a first coolant; providing another coolant circuit, such as the second coolant circuit 220, to process a second coolant different from the first coolant, where the first coolant circuit 210 and the second coolant circuit 220 are completely fluidly isolated; and providing a heat exchanger, such as heat exchanger 230, operatively coupled to the first coolant circuit 210 and the second coolant circuit 220 to process the first coolant and the second coolant, respectively. Such providing may also include providing the electrical power supply system 150.

At 504, the method 500 can include passing the first coolant through the first coolant circuit 210. Such passing can be such that none of the first coolant passes through the second coolant circuit 220. Further, such passing can be such that the first coolant passes through the heat exchanger 230. Operation 504 can further include passing the second coolant through the second coolant circuit 220. Such passing can be such that none of the second coolant passed through the first coolant circuit 210. Further, such passing can be such that the second coolant passes through the heat exchanger 230. The passing of the first coolant through the heat exchanger 230 and the passing of the second coolant through the heat exchanger 230 can be at the same time so the two different coolants can circulate within the heat exchanger 230 such that the second coolant (e.g., dielectric fluid) from the fuel cell 122 and the first coolant (e.g., ethylene glycol) pass within the heat exchanger 230 (separately) to dissipate the heat generated by the fuel cell 122 to the first coolant, which can then be dissipated by the radiator 202 using the fan 204. Such cooling can cool various components of the fuel cell machine 100, such as the electrical power supply system 150, including individual portions thereof (e.g., the fuel cell 122, the converter 126, the inverter 128, and the inductor(s) 129).

According to one or more embodiments, passing of the second coolant can include selectively passing the second coolant through a bypass path, such as bypass 224, without the second coolant going through the heat exchanger 230. In this regard, the bypass 224 may be operative to prevent or stop the second coolant from flowing through the heat exchanger 230 under a condition where a temperature of the second coolant is determined to be below a predetermined temperature value. As an example, the bypass 224 can include a valve (mechanical or electronically controller) operative to selectively pass the second coolant based on the temperature of the second coolant relative to the predetermined temperature value. As an example, the bypass 224 may be operative to bypass the heat exchanger 230 when the temperature of the second coolant exiting the fuel cell 122 is fifty-five degrees Celsius or less. Here, the valve 225 in the bypass 224 can open to pass the second coolant therethrough responsive to the temperature of the second coolant exiting the fuel cell 122 being fifty-five degrees Celsius or less. The valve 225 may be regarded as a three-way valve.

The method 500, at 506, can include determining whether a temperature of the first coolant exceeds a predetermined temperature threshold. The temperature of the first coolant can be measured by one or a plurality of sensors, such as sensors 208 shown in FIG. 4, where the outputs of the sensors 208 can be fed back to the ECU 130 for processing.

According to one or more embodiments of the present disclosure, the temperature feedback signals from one or more of the sensors 208 may be sent to the ECU 130 to control speed of the fan 204 for the radiator 202 and/or the speed of the fluid pump 212 at 508 and 510 of FIG. 5, respectively. In this regard, the operation 508 and the operation 510 of the method 500 can be performed at the same time (including same start times). Optionally, the ECU 130 may increase the speed of the fan 204 to a maximum value responsive to any of the temperature feedback signals from the sensors 208 exceeding a predetermined temperature threshold and/or may increase the speed of the fluid pump 212 to a maximum value responsive to any of the temperature feedback signals from the sensors 208 exceeding the predetermined temperature threshold. As shown in FIG. 4, the temperature sensors 208 can be provided at outputs of the electrical power supply system 150 and/or the heat exchanger 230, as the temperature of the first coolant as such outputs may be relatively higher than at the inputs to such components. As examples, a temperature of the second coolant downstream of an output of the heat exchanger 230 can be from 60° Celsius to 70° Celsius, inclusive, and/or a second temperature of the first coolant at input to electrical power supply system 150 can be from 50° Celsius to 80° Celsius, inclusive.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Further, as used herein, the term “circuitry” can refer to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present. This definition of “circuitry” can apply to all uses of this term in this application, including in any claims. As a further example, as used in this application, the term “circuitry” can also cover an implementation of merely a processor (or multiple processors) or portion of a processor and its (or their) accompanying software and/or firmware.

Use of the terms “data,” “content,” “information” and similar terms may be used interchangeably, according to some example embodiments of the present disclosure, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Aspects of the present disclosure have been described above with reference to flowchart illustrations and/or block diagrams of methods, apparatus (systems) and computer program products according to embodiments of the present disclosure. In this regard, the flowchart and block diagrams in the Figures illustrate the architecture, functionality, and operation of possible implementations of systems, methods and computer program products according to various embodiments of the present disclosure. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosed subject matter can also be as set forth according to the following parentheticals.

(1) An integrated cooling system for a fuel cell-powered vehicle comprising: a first coolant circuit to process a first coolant, the first coolant being an ethylene glycol mixture; a second coolant circuit to process a second coolant, the second coolant being a dielectric fluid having a conductivity below a predetermined conductivity value; a liquid-liquid heat exchanger operatively coupled to the first coolant circuit and the second coolant circuit; electrical circuitry to provide electrical power for the fuel cell-powered vehicle; and a proton exchange membrane (PEM) fuel cell, wherein the first coolant circuit and the second coolant circuit are fluidly isolated from each other, wherein the first coolant circuit includes a first fluid pump to circulate the first coolant through the first coolant circuit, wherein the proton exchange membrane (PEM) fuel cell includes a second fluid pump to circulate the second coolant through the second coolant circuit, and wherein the first coolant circuit is without any three-way valves.

(2) The integrated cooling system according to (1), wherein the second coolant circuit is without any three-way valves.

(3) The integrated cooling system according to (1) or (2), wherein the second coolant circuit includes a bypass path at an output of the proton exchange membrane (PEM) fuel cell and an input of proton exchange membrane (PEM) fuel cell to selectively bypass the second coolant from flowing through the liquid-liquid heat exchanger.

(4) The integrated cooling system according to any one of (1) to (3), wherein the bypass path includes a valve to selectively pass the second coolant based on a temperature of the second coolant being below a predetermined temperature value.

(5) The integrated cooling system according to any one of (1) to (4), wherein a temperature of the second coolant downstream of an output of the liquid-liquid heat exchanger is from 60° Celsius to 70° Celsius, inclusive.

(6) The integrated cooling system according to any one of (1) to (5), wherein a temperature of the first coolant at input to the electrical circuitry is from 50° Celsius to 80° Celsius, inclusive.

(7) The integrated cooling system according to any one of (1) to (6), further comprising control circuitry to receive temperature feedback signals from different portions of the first fluid circuit to control speed of a radiator fan and to control speed of the first fluid pump responsive to the temperature feedback signals.

(8) The integrated cooling system according to any one of (1) to (7), wherein the control circuitry is configured to increase the speed of the radiator fan to a maximum value responsive to any of the temperature feedback signals exceeding a predetermined temperature threshold.

(9) The integrated cooling system according to any one of (1) to (8), wherein the control circuitry is configured to increase the speed of the first fluid pump to a maximum value responsive to any of the temperature feedback signals exceeding a predetermined temperature threshold.

(10) A method comprising: providing a first coolant circuit to process a first coolant; providing a second coolant circuit to process a second coolant, the second coolant being a dielectric fluid, the second coolant circuit including proton exchange membrane (PEM) fuel cell; providing a liquid-liquid heat exchanger operatively coupled to the first coolant circuit and the second coolant circuit, wherein the first coolant circuit and the second coolant circuit are fluidly isolated from each other, and wherein the first coolant circuit is without any three-way valves.

(11) The method according to (10), further comprising: passing the first coolant through the first coolant circuit without the first coolant going through the second coolant circuit; and passing the second coolant through the second coolant circuit without the second coolant going through the first coolant circuit, wherein said passing the first coolant includes passing the first coolant through the liquid-liquid heat exchanger.

(12) The method according to (10) or (11), wherein said passing the second coolant includes passing the second coolant through the liquid-liquid heat exchanger.

(13) The method according to any one of (10) to (12), wherein said passing the second coolant includes selectively passing the second coolant through a bypass path without the second coolant going through the liquid-liquid heat exchanger.

(14) The method according to any one of (10) to (13), further comprising: receiving one or more temperature feedback signals from respective one or more different portions of the first fluid circuit; and controlling flow of the first coolant through the first coolant circuit responsive to said receiving one or more temperature feedback signals from the respective one or more different portions of the first fluid circuit.

(15) The method according to any one of (10) to (14), further comprising: receiving one or more temperature feedback signals from respective one or more portions of the first fluid circuit; and controlling a speed of a radiator fan motor responsive to said receiving one or more temperature feedback signals from the respective one or more different portions of the first fluid circuit.

(16) An off-highway truck comprising: a first coolant circuit to process a first coolant; a second coolant circuit to process a second coolant, the second coolant being a dielectric fluid; a liquid-liquid heat exchanger operatively coupled to the first coolant circuit and the second coolant circuit; and a proton exchange membrane (PEM) fuel cell, wherein the first coolant circuit and the second coolant circuit are fluidly separated from each other.

(17) The off-highway truck according to (16), wherein the first coolant circuit and/or the second coolant circuit are/is without any three-way valves.

(18) The off-highway truck according to (16) or (17), wherein the second coolant circuit includes a bypass path at an output of the proton exchange membrane (PEM) fuel cell and an input of proton exchange membrane (PEM) fuel cell to selectively bypass the second coolant from flowing through the liquid-liquid heat exchanger.

(19) The off-highway truck according to any one of (16) to (18), further comprising control circuitry to receive temperature feedback signals from different portions of the first fluid circuit to control speed of a radiator fan and to control speed of the first fluid pump responsive to the temperature feedback signals, wherein the control circuitry is configured to increase the speed of the radiator fan to a maximum value responsive to any of the temperature feedback signals exceeding a predetermined temperature threshold, and wherein the control circuitry is configured to increase the speed of the first fluid pump to a maximum value responsive to any of the temperature feedback signals exceeding a predetermined temperature threshold.

(20) The off-highway truck according to any one of (16) to (19), wherein a first temperature of the second coolant downstream of an output of the liquid-liquid heat exchanger is from 60° Celsius to 70° Celsius, inclusive, and wherein a second temperature of the first coolant at input to electrical power circuitry of the off-highway truck is from 50° Celsius to 80° Celsius, inclusive.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

While aspects of the present disclosure have been particularly shown and described with reference to the embodiments above, it will be understood by those skilled in the art that various additional embodiments may be contemplated by the modification of the disclosed machines, assemblies, systems, and methods without departing from the spirit and scope of what is disclosed. Such embodiments should be understood to fall within the scope of the present disclosure as determined based upon the claims and any equivalents thereof.

1. An integrated cooling system for a fuel cell-powered vehicle comprising:
a first coolant circuit to process a first coolant, the first coolant being an ethylene glycol mixture;
a second coolant circuit to process a second coolant, the second coolant being a dielectric fluid having a conductivity below a predetermined conductivity value;
a liquid-liquid heat exchanger operatively coupled to the first coolant circuit and the second coolant circuit;
electrical circuitry to provide electrical power for the fuel cell-powered vehicle; and
a proton exchange membrane (PEM) fuel cell,
wherein the first coolant circuit and the second coolant circuit are fluidly isolated from each other,
wherein the first coolant circuit includes a first fluid pump to circulate the first coolant through the first coolant circuit,
wherein the proton exchange membrane (PEM) fuel cell includes a second fluid pump to circulate the second coolant through the second coolant circuit, and
wherein the first coolant circuit is without any three-way valves.

2. The integrated cooling system according to claim 1, wherein the second coolant circuit is without any three-way valves.

3. The integrated cooling system according to claim 1, wherein the second coolant circuit includes a bypass path at an output of the proton exchange membrane (PEM) fuel cell and an input of proton exchange membrane (PEM) fuel cell to selectively bypass the second coolant from flowing through the liquid-liquid heat exchanger.

4. The integrated cooling system according to claim 3, wherein the bypass path includes a valve to selectively pass the second coolant based on a temperature of the second coolant being below a predetermined temperature value.

5. The integrated cooling system according to claim 1, wherein a temperature of the second coolant downstream of an output of the liquid-liquid heat exchanger is from 60° Celsius to 70° Celsius, inclusive.

6. The integrated cooling system according to claim 1, wherein a temperature of the first coolant at input to the electrical circuitry is from 50° Celsius to 80° Celsius, inclusive.

7. The integrated cooling system according to claim 1, further comprising control circuitry to receive temperature feedback signals from different portions of the first fluid circuit to control speed of a radiator fan and to control speed of the first fluid pump responsive to the temperature feedback signals.

8. The integrated cooling system according to claim 7, wherein the control circuitry is configured to increase the speed of the radiator fan to a maximum value responsive to any of the temperature feedback signals exceeding a predetermined temperature threshold.

9. The integrated cooling system according to claim 7, wherein the control circuitry is configured to increase the speed of the first fluid pump to a maximum value responsive to any of the temperature feedback signals exceeding a predetermined temperature threshold.

10. A method comprising:
providing a first coolant circuit to process a first coolant;
providing a second coolant circuit to process a second coolant, the second coolant being a dielectric fluid, the second coolant circuit including proton exchange membrane (PEM) fuel cell; and
providing a liquid-liquid heat exchanger operatively coupled to the first coolant circuit and the second coolant circuit,
wherein the first coolant circuit and the second coolant circuit are fluidly isolated from each other, and
wherein the first coolant circuit is without any three-way valves.

11. The method according to claim 10, further comprising:
passing the first coolant through the first coolant circuit without the first coolant going through the second coolant circuit; and
passing the second coolant through the second coolant circuit without the second coolant going through the first coolant circuit,
wherein said passing the first coolant includes passing the first coolant through the liquid-liquid heat exchanger.

12. The method according to claim 11, wherein said passing the second coolant includes passing the second coolant through the liquid-liquid heat exchanger.

13. The method according to claim 11, wherein said passing the second coolant includes selectively passing the second coolant through a bypass path without the second coolant going through the liquid-liquid heat exchanger.

14. The method according to claim 11, further comprising:
receiving one or more temperature feedback signals from respective one or more different portions of the first fluid circuit; and
controlling flow of the first coolant through the first coolant circuit responsive to said receiving one or more temperature feedback signals from the respective one or more different portions of the first fluid circuit.

15. The method according to claim 11, further comprising:
receiving one or more temperature feedback signals from respective one or more portions of the first fluid circuit; and
controlling a speed of a radiator fan motor responsive to said receiving one or more temperature feedback signals from the respective one or more different portions of the first fluid circuit.

16. An off-highway truck comprising:
a first coolant circuit to process a first coolant;
a second coolant circuit to process a second coolant, the second coolant being a dielectric fluid;
a liquid-liquid heat exchanger operatively coupled to the first coolant circuit and the second coolant circuit; and
a proton exchange membrane (PEM) fuel cell,
wherein the first coolant circuit and the second coolant circuit are fluidly separated from each other.

17. The off-highway truck according to claim 16, wherein the first coolant circuit and/or the second coolant circuit are/is without any three-way valves.

18. The off-highway truck according to claim 16, wherein the second coolant circuit includes a bypass path at an output of the proton exchange membrane (PEM) fuel cell and an input of proton exchange membrane (PEM) fuel cell to selectively bypass the second coolant from flowing through the liquid-liquid heat exchanger.

19. The off-highway truck according to claim 16, further comprising control circuitry to receive temperature feedback signals from different portions of the first fluid circuit to control speed of a radiator fan and to control speed of the first fluid pump responsive to the temperature feedback signals,
wherein the control circuitry is configured to increase the speed of the radiator fan to a maximum value responsive to any of the temperature feedback signals exceeding a predetermined temperature threshold, and
wherein the control circuitry is configured to increase the speed of the first fluid pump to a maximum value responsive to any of the temperature feedback signals exceeding a predetermined temperature threshold.

20. The off-highway truck according to claim 16,
wherein a first temperature of the second coolant downstream of an output of the liquid-liquid heat exchanger is from 60° Celsius to 70° Celsius, inclusive, and
wherein a second temperature of the first coolant at input to electrical power circuitry of the off-highway truck is from 50° Celsius to 80° Celsius, inclusive.
